(19) United States
(12) Patent Application Publication
(10) Pub. No.: US 2013/0151955 A1
(43) Pub. Date: Jun. 13, 2013

(54) PHYSICAL EFFECTS FOR ELECTRONIC BOOKS

(71) Applicant: Mechell Williams, Rock Springs, WY (US)

(72) Inventor: Mechell Williams, Rock Springs, WY (US)

(21) Appl. No.: 13/708,795

(22) Filed: Dec. 7, 2012

Related U.S. Application Data
(60) Provisional application No. 61/568,701, filed on Dec. 9, 2011.

(51) Int. Cl. G06F 17/24

(52) U.S. Cl. CPC G06F 17/24
USPC 715/255

(57) ABSTRACT

An apparatus, system, and method are disclosed for generating physical effects for electronic books. A communication interface is configured to receive an effect request from an electronic book reader in response to the electronic book reader presenting a portion of an electronic book. One or more effect generators are operable to provide a physical effect specified by the electronic book reader. An effect controller is configured to operate the effect generators in response to receiving the effect request using the communication interface.

### CROSS-REFERENCES TO RELATED APPLICATIONS

This application claims the benefit of U.S. Provisional Patent Application No. 61/568,701 entitled “4De-Bookpad” and filed on Dec. 9, 2011 for Mechell Williams, which is incorporated herein by reference.

### TECHNICAL FIELD

The subject matter disclosed herein relates to electronic books and more particularly relates to physical effects for electronic books.

### BACKGROUND

The experience of reading an electronic book may be similar to the experience of reading a paper book, as text resembling a page of a paper book is presented on the display of an electronic book reader. However, it can be difficult to immerse oneself in a book simply by reading words off a page or by listening to words being read. The difficulty of engaging the information in a book is increased if the reader is young, or has visual, hearing, or sensory disabilities. People's enjoyment of electronic books, as well as their ability to learn and retain information, may be heightened by interactivity and/or stimulation of the physical senses.

### SUMMARY

From the foregoing discussion, it should be apparent that a need exists for an apparatus, system, and method for generating physical effects for electronic books. Such an apparatus, system, and method would provide an interactive and/or sense-engaging experience for an electronic book's user. Electronic books with physical effects may be helpful for people with visual, hearing, or other sensory disabilities, as well as for children and teens.

The present invention has been developed in response to the present state of the art, and in particular, in response to the problems and needs in the art that have not yet been fully solved by currently available electronic book readers. Accordingly, the present invention has been developed to provide an apparatus, system, and method for generating physical effects for electronic books that overcome many or all of the above-discussed shortcomings in the art.

An apparatus is presented for generating physical effects for electronic books. In one embodiment, a communication interface is configured to receive an effect request from an electronic book reader in response to the electronic book reader presenting a portion of an electronic book. In a further embodiment, one or more effect generators are operable to provide a physical effect specified by the electronic book reader. In some embodiments, an effect controller is configured to operate one or more of the effect generators in response to receiving the effect request using the communication interface.

In one embodiment, the effect request is for an air current effect associated with the presented portion of the electronic book, and an effect generator includes a fan. In another embodiment, the effect request is for a temperature effect associated with the presented portion of the electronic book, and an effect generator includes a temperature-controllable surface. In a further embodiment, the effect request is for a scent effect associated with the presented portion of the electronic book, and an effect generator includes a scent emitter. In a certain embodiment, the effect request is for a vibration effect associated with the presented portion of the electronic book, and an effect generator includes a vibratable element. In some embodiments, the effect request is for a luminescent effect associated with the presented portion of the electronic book, and an effect generator includes a luminescent element.

In one embodiment, the electronic book reader sends the effect request using the communication interface automatically in response to detecting a predefined trigger within the presented portion of the electronic book. In another embodiment, the electronic book reader sends the effect request using the communication interface in response to receiving user input in association with the presented portion of the electronic book. In a certain embodiment, a customization module is configured to receive user-selected content and present the user-selected content with the presented portion of the electronic book.

In one embodiment, a housing is shaped to receive the electronic book reader. In a further embodiment, the housing includes the communication interface. In a certain embodiment, the effect generators are coupled to the housing.

A system is presented for generating physical effects for electronic books. In one embodiment, an electronic book reader is configured to present an electronic book. In a further embodiment, a communication interface is configured to receive an effect request from the electronic book reader in response to the electronic book reader presenting a portion of the electronic book. In certain embodiments, one or more effect generators are coupled to a housing of the electronic book reader. In some embodiments, each effect generator is operable to provide a physical effect specified by the electronic book reader. In a further embodiment, an effect controller is configured to operate one or more of the effect generators in response to receiving the effect request using the communication interface.

In one embodiment, an effect generator includes a fan, a temperature-controllable surface, a scent emitter, a vibratable element, and/or a luminescent element. In a certain embodiment, the housing is detachably connectable to the electronic book reader. In another embodiment, the housing is an integral portion of the electronic book reader.

In one embodiment, the electronic book reader includes a display capable of displaying images with a three-dimensional effect. In another embodiment, the electronic book reader includes a touch-sensitive display. In a further embodiment, the electronic book reader is configured to display moving images. In some embodiments, the electronic book reader is configured to present the electronic book by audibly reading the electronic book.

A method is presented for generating physical effects for electronic books. In one embodiment, the method includes presenting a portion of an electronic book using an electronic book reader. In a further embodiment, the method includes receiving an effect request from the electronic book reader in response to the electronic book reader presenting the portion of the electronic book. In a certain embodiment, the method includes operating one or more effect generators to provide a physical effect specified by the electronic book reader in response to receiving the effect request. In another embodiment, the method includes generating the effect request in response to detecting a predefined trigger within the presented portion of the electronic book.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. In light of this disclosure, it is clear that the various embodiments of the disclosure may be practiced without one or more of the specific features or advantages of a particular embodiment. In other instances, additional features and advantages may be recognized in certain embodiments that may not be present in all embodiments of the disclosure. These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1A is a front view illustrating one embodiment of a system for generating physical effects for electronic books;

FIG. 1B is a back view of a system for generating physical effects for electronic books;

FIG. 2 is a schematic block diagram illustrating another embodiment of a system for generating physical effects for electronic books;

FIG. 3 is a schematic block diagram, illustrating one embodiment of an electronic book reader; and

FIG. 4 is a schematic flow chart diagram illustrating one embodiment of a method for generating physical effects for electronic books.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc. or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. In light of this disclosure, it is clear, however, that the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

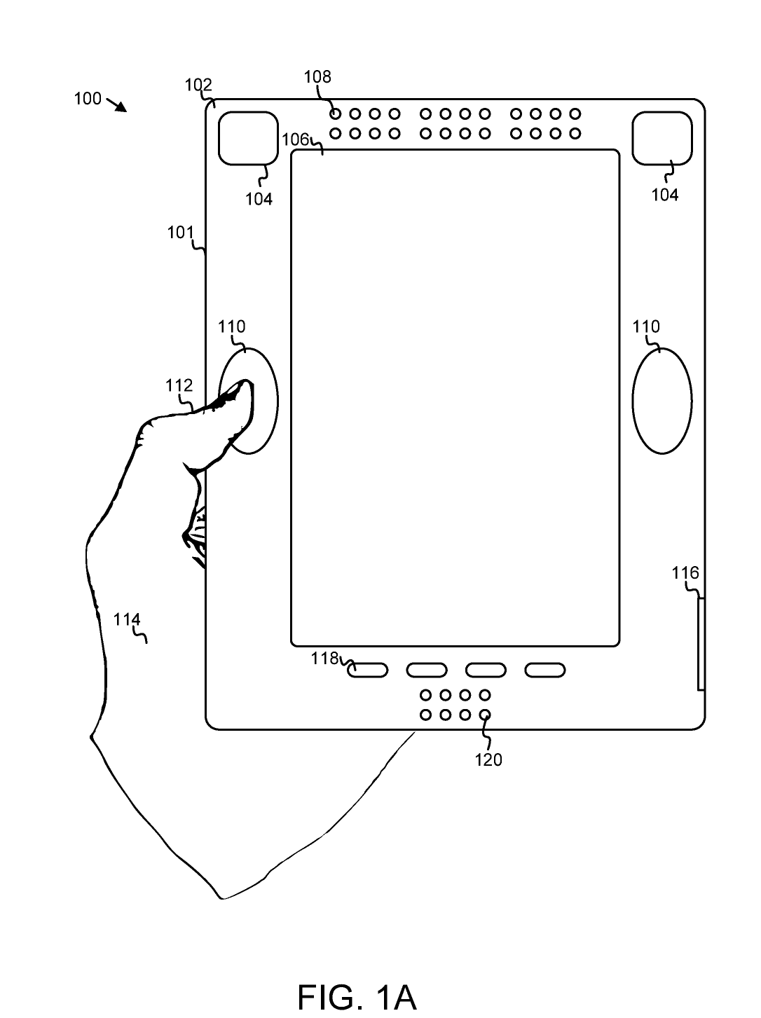

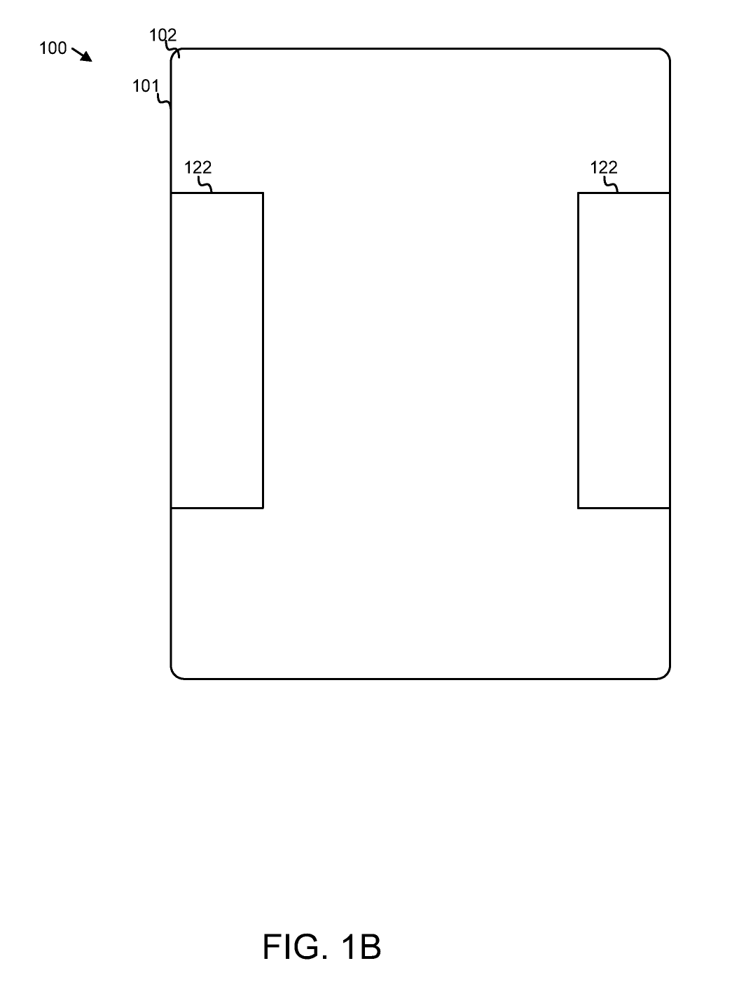

FIG. 1A depicts a front view illustrating one embodiment of a system 100 for generating physical effects for electronic books. In the depicted embodiment, the system 100 includes a housing 102, one or more luminescent elements 104, a display 106, one or more scent emitters 108, one or more temperature-controllable surfaces 110, a data interface 116, one or more hardware inputs 118, and one or more fan vents 120.

In general, the system 100 generates physical effects for electronic books. In one embodiment, a communication interface is configured to receive an effect request from an electronic book reader 101 in response to the electronic book reader 101 presenting a portion of an electronic book. In a further embodiment, one or more effect generators 104, 106, 108, 110, 120 are operable to provide a physical effect specified by the electronic book reader 101. In some embodiments, an effect controller is configured to operate one or more of the effect generators 104, 106, 108, 110, 120 in response to receiving the effect request using the communication interface. By providing physical effects in response to an electronic book reader 101 presenting portions of an electronic book, the system 100 provides a more immersive and/or engaging experience than reading a paper book or a traditional electronic book.

In one embodiment, the system 100 may present physical effects for the electronic book using effect generators 104, 106, 108, 110, 120 coupled to integrated with and/or housed within a housing 102. In another embodiment, the housing 102 may also comprise the communication interface configured to receive an effect request from the electronic book reader 101. In a further embodiment, the housing 102 may comprise materials such as metal, plastic, composite materials or other durable materials suitable for use with an electronic book reader 101.

In one embodiment, the housing 102 and the display 106 may be integral portions of an electronic book reader 101. In another embodiment, the display 106 may be a portion of an electronic book reader 101, and the housing 102 may be detachably connectable to the electronic book reader 101. In a further embodiment, the housing 102 may be shaped to receive an electronic book reader 101 including the display 106. For example, in a certain embodiment, the housing 102 may act as a case for the electronic book reader 101.

The electronic book reader 101, in one embodiment, is an electronic device for presenting text, images, video, animations, and/or sound of electronically published materials such as books, journals, newspapers, magazines, multimedia presentations, applications, or the like. For example, the electronic book reader 101 may support one or more electronic book formats such as an electronic publication (“EPUB”) or other extensible markup language (“XML”)-based format, a portable document format (“PDF”), a hypertext markup language (“HTML”) format, a proprietary format, may support electronic books embedded in or presented by a dedicated application, or the like.

In a certain embodiment, the electronic book reader 101 includes an integral housing 102 coupled to effect generators 104, 106, 108, 110, 120. In another embodiment, where the housing 102 acts as a removable case for the electronic book reader, or is otherwise detachably connectable to the electronic book reader, the electronic book reader may include a tablet or slate computer such as an Apple iPad® tablet device, a smartphone, a portable media player, an electronic book reader such as an Amazon Kindle® electronic book reader or a Barnes & Noble Nook® electronic book reader, or another electronic display device.

In one embodiment, whether the electronic book reader 101 is integrated with the housing 102, or detachably connectable from the housing 102, the system 100 may use the display 106 as part of the electronic book reader 101 to present the visual content of an electronic book, such as text, illustrations, or the like. In some embodiments, the display 106 may include a liquid crystal display (“LCD”), a light emitting diode (“LED”) display, a plasma display, an organic LED (“OLED”) display, a surface-conduction electron-emitter display (“SED”), an electronic paper display, a cathode ray tube (“CRT”) display, a laser display, a projection display, or the like.

In one embodiment, the display 106 may be a 3D display, capable of displaying images, electronic books, videos, or the like with a three-dimensional effect. In some embodiments, the display 106 may produce images with three-dimensional effects using a system with specialized glasses, such as anaglyph 3D using red and cyan glasses, polarization systems, eclipse systems using glasses with active shutters, interference filter systems, or the like. In another embodiment, the display 106 may produce images with three-dimensional effects using an autostereoscopic system without glasses, such as a screen including a lenticular lens array, a parallax barrier, or the like.

In one embodiment, the electronic book reader 101 of the system 100 is configured to display moving images, animations, or videos using the display 106. For example, in a certain embodiment, the electronic book reader 101 may be configured to display movies or other videos as well as electronic books. In another embodiment, the electronic book reader 101 may display a page of an electronic book including an embedded video, animation, or other moving picture. The electronic book reader 101, in a further embodiment, may be configured to execute applications or other computer executable code.

In one embodiment, in addition to using a display 106, the electronic book reader 101 may be configured to present an electronic book by audibly reading the electronic book. For example, in a certain embodiment, the electronic book reader 101 may use a text-to-speech system to audibly read portions of an electronic book in a synthesized voice. In another embodiment, the electronic book reader 101 may be configured to audibly read prerecorded portions of an electronic book such as an audiobook.

In one embodiment, the electronic book reader 101 may be configured to present an electronic book using an in-vehicle entertainment system. For example, in some embodiments, the electronic book reader 101 may audibly read an electronic book over a car's speakers, or present text of an electronic book on a display in the passenger area of a van. In a further embodiment, the system 100 may provide physical effects compatible with driving, such as fresh scents or the like, in response to the electronic book reader 101 presenting a portion of an electronic book using an in-vehicle entertainment system. The electronic book reader 101, in certain embodiments, may comprise an in-vehicle entertainment system, navigation system, or other in-vehicle electronic display device.

In one embodiment, the display 106 may be a touch-sensitive display. For example, the display 106 may detect touch input from a user using one or more sensors such as resistive, capacitive, surface acoustic wave, surface capacitance, projected capacitance, infrared, strain gauge, optical, dispersive signal, acoustic, or other touchscreen sensors. The display 106 or other touch-sensitive area, in certain embodiments, may detect various forms of touch, such as from a finger or a hand 114, or from a passive object such as a stylus or pen. In some embodiments, user input the system 100 receives via a touch-sensitive display 106 may trigger physical effects. For example, in one embodiment, the system 100 may present a page of an electronic book describing a desert scene, and a user may tap a predefined region of the page on the touch-sensitive display 106 to trigger physical effects such as heat, air currents simulating wind, the smell of sagebrush, or the like.

Similarly, in some embodiments, the system 100 may receive user input from one or more hardware inputs 118. In one embodiment, the display 106 may not be touch sensitive, but a user may trigger physical effects and/or otherwise control the electronic book reader 101 using the hardware inputs 118. In another embodiment, the hardware inputs 118 are auxiliary inputs to a touch-sensitive display 106 of the electronic book reader 101. In another embodiment, the system 100 may include a touch-sensitive display 106 without the hardware inputs 118. The hardware inputs 118, in one embodiment, may include buttons, keys, dials, knobs, rockers, switches, and/or other types of hardware inputs.

In one embodiment, the system 100 is configured to receive electronic books for presentation by the electronic book reader 101 via a data interface 116. In one embodiment, the data interface 116 is a storage interface configured to receive data from storage media such as a Secure Digital (“SD”) card, MultiMediaCard (“MMC”), CompactFlash device, or the like. In another embodiment, the data interface 116 may be a wired interface for communicating data, such as a Universal Serial Bus (“USB”) port, a Mini USB port, a Micro USB port, a port using the Institute of Electrical and Electronics Engineers (“IEEE”) 1394 protocol, a dock interface for the electronic book reader 101, or the like. In a further embodiment, the data interface 116 may receive electronic books wirelessly via a phone data network, wireless local area network, or the like.

In one embodiment, one or more effect generators 104, 106, 108, 110, 120 coupled to the housing 102 may be operable to provide physical effects specified by the electronic book reader 101. Physical effects provided by the system 100, in various embodiments, may include any visual or non-visual sensations experienced by the user of an electronic book reader 101, other than those visual sensations produced by the display 106. In some embodiments, the physical effects may include one or more non-visual, non-auditory sensations. In another embodiment, physical effects may include visual or auditory sensations other than those produced by the display 106 or a speaker of the electronic book reader 101.

In a certain embodiment, the system 100 may provide a physical effect such as a luminescent, or glow-in-the-dark effect to engage a user's visual senses. In another embodiment, the system 100 may provide a physical effect to engage a user's non-visual senses. For example, in one embodiment, the system 100 may engage a user's sense of smell by using scent emitters 108 to provide scent effects. Similarly, in another embodiment, the system 100 may engage a user's sense of touch using physical effects such as air currents, hot or cold temperatures, vibrations, tingling sensations, effects which tilt the electronic book reader 101, or the like. In various embodiments, effect generators 104, 106, 108, 110, 120 of the system 100 may provide a variety of different physical effects.

In the depicted embodiment, the effect generators 104, 106, 108, 110, 120 coupled to the housing 102 include the luminescent elements 104, scent emitters 108, temperature-controllable surfaces 110, and fan vents 120. The electronic book reader 101 presents an electronic book, or a portion thereof, and sends an effect request associated with the presented material. In one embodiment, presenting an electronic book may include displaying a page or pages of the electronic book, audibly reading portions of the electronic book, or the like.

In one embodiment, the electronic book reader 101 sends an effect request for a luminescent effect associated with the presented portion of the electronic book, and an effect generator includes one or more luminescent elements 104. In some embodiments, a luminescent element 104 may produce light for physical effects by chemiluminescence, electroluminescence, photoluminescence, radioluminescence, or the like. In a certain embodiment, a luminescent element 104 may provide an effect such as a predetermined glow-in-the- dark accent associated with a portion of an electronic book. For example, in one embodiment, the electronic book reader 101 may use the rounded rectangular luminescent elements 104 of the depicted embodiment to provide a generally glowing effect at certain parts of a book. In another embodiment, a supplier of an electronic book may provide additional luminescent elements 104 in shapes corresponding to the book. For example, in a further embodiment, an electronic book of “The Hound of the Baskervilles” may include a luminescent element 104 in the shape of a dog, configured to glow at appropriate points in the story.

In one embodiment, the electronic book reader 101 sends an effect request for a scent effect associated with the presented portion of the electronic book, and an effect generator includes one or more scent emitters 108. In some embodiments, a scent emitter 108 may include scented chemical mixtures, or scents, dispersed through vents in the housing 102. In a further embodiment, a scent emitter 108 may include a fan to direct or accelerate the emitted scents. In another embodiment, the scent emitter 108 may use diffusion, without a fan, to convey a scent to the user.

In one embodiment, a scent emitter 108 may include one scent. For example, in a certain embodiment, the electronic book reader 101 may use the scent of roses as a scent effect for enhancing several different electronic books including romance literature. In another embodiment, a scent emitter 108 may include an array, or matrix of scents. In a further embodiment, the scent emitter 108 may select one scent from an array of scents for the requested scent effect by opening one vent but not others, by heating a scent solution at a particular location without heating other scent solutions, or by similar means. For example, in one embodiment a scent emitter 108 may include a matrix of wires, with different-smelling scent solutions at each intersection, so that the scent emitter 108 may emit a scent by heating the scent solution at a particular intersection of the wires.

In one embodiment, a scent emitter 108 may include a replaceable scent cartridge. Using a replaceable scent cartridge allows refilling or replacing scents. For example, in a certain embodiment, a scent emitter 108 may use a standard scent cartridge to emit common scents, or to combine frequently used base scents to produce more complex scent effects. In a further embodiment, as the standard scent cartridge becomes depleted, the cartridge may be replaced, or its individual scents may be refilled. In another embodiment, an electronic book supplier may provide electronic books with scent cartridges that replace or supplement a standard scent cartridge. For example, in some embodiments, an electronic book supplier may provide an electronic cookbook with a customized scent cartridge including scents of the foods in the cookbook.

In one embodiment, the electronic book reader 101 sends an effect request for a temperature effect associated with the presented portion of the electronic book, and an effect generator includes one or more temperature-controllable surfaces 110. In various embodiments, a temperature-controllable surface 110 may provide temperature effects including hot or cold sensations of various intensities. For example, in one embodiment, the presented portion of the electronic book may describe a summer day, and a temperature-controllable surface would provide a mildly warm sensation. In another embodiment, the presented portion of the electronic book may describe a hot desert scene, and a temperature-controllable surface 110 would provide a hotter sensation. In yet another embodiment, the presented portion of the electronic book may describe a winter scene, and a temperature-controllable surface 110 may provide a cold sensation.

In one embodiment, a temperature-controllable surface 110 may include a solid state heat pump such as a Peltier device, or a similar mechanism for both heating and cooling the surface. In another embodiment, a temperature-controllable surface 110 may circulate a refrigerated liquid to cool the surface. In yet another embodiment, a temperature-controllable surface 110 may use a resistive heating element to heat the surface. In a further embodiment, a temperature-controllable surface 110 may use a temperature sensor such as a thermocouple, thermistor, or the like, to monitor the temperature of the surface as part of a feedback loop for stabilizing the temperature of the surface. In light of this disclosure, it is clear that many types of temperature-controllable surfaces 110 may be used.

In the depicted embodiment of the system 100, the temperature-controllable surfaces 110 are disposed within recesses on either side of the housing 102. In this configuration, a user may support the system 100 with one or both hands 114, so that one or both of the user's thumbs 112 will touch the temperature-controllable surface 110 in the recess. A recess provides a natural resting place for a user's thumb 112, so that the temperature-controllable surface 110 may be as small as a thumbprint, and still be felt by the user. In another embodiment, temperature-controllable surfaces 110 may be disposed flush with, or elevated from the housing 102, rather than in a recessed configuration.

In one embodiment, the electronic book reader 101 sends an effect request for an air current effect associated with the presented portion of the electronic book, and an effect generator includes a fan, with one or more fan vents 120. In a further embodiment, a fan may direct air through the fan vents 120 to the user producing an air current resembling wind. For example, in one embodiment, the presented portion of the electronic book may describe an outdoor scene on a street with a mild breeze, and a low-speed fan may direct a slow air current through the fan vents 120. In another embodiment, the presented portion of the electronic book may describe a storm at sea, and a high-speed fan may direct a fast air current through the fan vents 120.

Various embodiments of the system 100 may include other effect generators, not shown in FIG. 1A. For example, in one embodiment, the electronic book reader 101 sends an effect request for a vibration effect associated with the presented portion of the electronic book, and an effect generator includes a vibratable element. In a further embodiment, a vibratable element may include a motor driving a small eccentric weight to produce vibrations. In another embodiment, an effect generator may include a larger eccentric weight moved by a motor to produce a tilting effect for the electronic book reader 101. In yet another embodiment, an effect generator may include electrical contacts capable of producing a tingling effect.

In some embodiments, the effect generators 104, 106, 108, 110, 120 may provide physical effects specified by an electronic book reader 101 either alone or in combination. For example, in one embodiment, the electronic book reader 101 may present a portion of a cookbook and use a scent emitter 108 to provide a single scent effect to engage a user with the scent of food. In another embodiment, the electronic book reader 101 may present a portion of a novel depicting an adventure at sea, and use the scent emitter 108 to provide the smell of sea spray, the fan and fan vents 120 to provide the sensation of wind, and speakers to provide sounds of waves and sea birds. Although certain effect generators 104, 106, 108, 110, 120 are described herein, in connection with the system 100 of FIG. 1A and FIG. 1B, it is clear, in light of this disclosure, that a variety of effect generators, in various combinations, may be used to provide physical effects

FIG. 1B depicts a back view of the system 100 of FIG. 1A. In the depicted embodiment, one or more additional surfaces 122 for effect generators are disposed within the housing 102. In one embodiment, the additional surfaces 122 for effect generators are disposed on one or both sides of the housing 102, so that a hand 114 of a user will contact an additional surface 122 when the user holds the housing 102. Although, in the depicted embodiment, the additional surfaces 122 are depicted as flat surfaces, in another embodiment, the additional surfaces 122 may be shaped to provide a comfortable grip for a user, or the like.

In one embodiment, the additional surfaces 122 are temperature-controllable surfaces, similar to the temperature-controllable surfaces 110 of FIG. 1A, for an effect generator providing a temperature effect. In another embodiment, the additional surfaces 122 are electrical contacts for an effect generator providing a tingling effect. In various embodiments, the additional surfaces 122 may allow a user to physically contact various effect generators when the user holds the housing 102 in his or her hand 114.

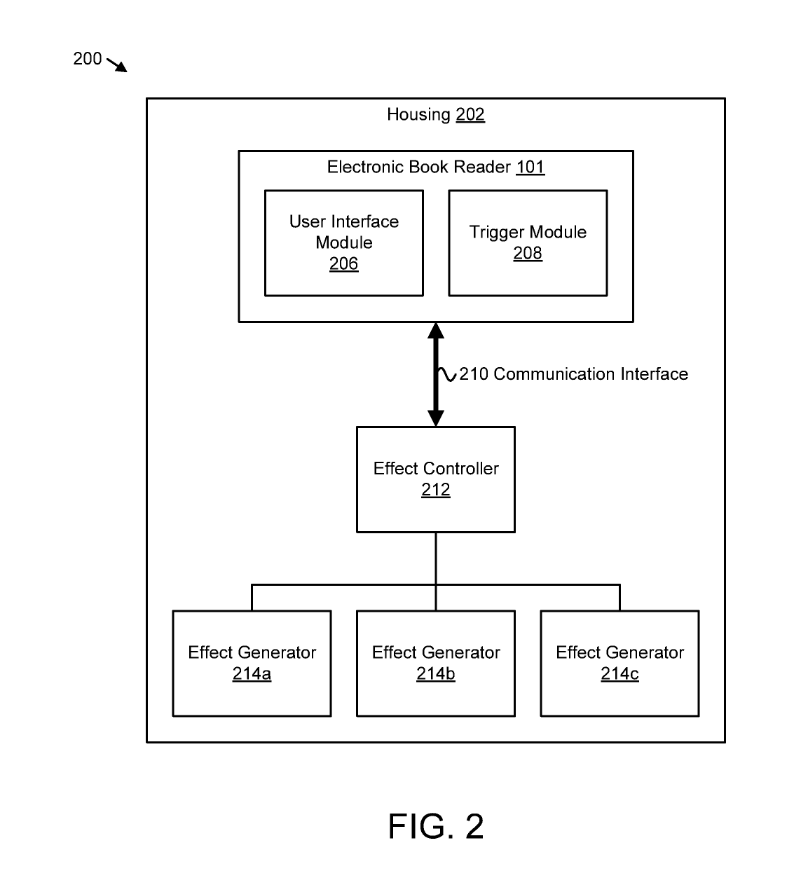

FIG. 2 depicts another embodiment of a system 200 for generating physical effects for electronic books. The system 200, in some embodiments, may be substantially similar to the system 100 described above with regard to FIG. 1A and FIG. 1B. In the depicted embodiment, the system 200 includes a housing 202, an electronic book reader 101, a communication interface 210, and effect controller 212, and one or more effect generators 214a-c. The electronic book reader 101, in the depicted embodiment, includes a user interface module 206 and a trigger module 208.

The housing 202, electronic book reader 101, and effect generators 214a-c may be configured substantially as described above with regard to FIG. 1A and FIG. 1B. The electronic book reader 101 is configured to present an electronic book, or a portion thereof. The electronic book reader 101 may be disposed within the housing 202, as depicted, or may be detachably connectable to the housing 202.

Each effect generator 214a-c is operable to provide a physical effect specified by the electronic book reader 101. In one embodiment, the effect generators 214a-c are coupled to the housing 202. Although the system 200 is depicted with three effect generators 214a-c, it may include fewer or more effect generators 214 in various embodiments, such as luminescent elements 104, scent emitters 108, temperature-controllable surfaces 110, fan vents 120, vibratable elements, or the like, or any suitable combination of the foregoing.

In one embodiment, a communication interface 210 is configured to receive an effect request from an electronic book reader 101 in response to the electronic book reader 101 presenting a portion of an electronic book. In another embodiment, the communication interface 210 may receive additional data from the electronic book reader 101 without transmitting data back to the electronic book reader 101. In a further embodiment, the communication interface 210 may both send and receive data to and from the electronic book reader 101.

In one embodiment, where the housing 202 is integral to the electronic book reader 101, the communication interface 210 may comprise an internal connection of the electronic book reader 101. In another embodiment, where the housing 202 is shaped to receive the electronic book reader 101, the housing 202 may comprise the communication interface 210 as a plug, port, or the like configured to receive an effect request from the electronic book reader 101. For example, a housing 202 that is detachably connectable to the electronic book reader 101 may comprise a communication interface 210 such as a USB port, a Mini USB port, a Micro USB port, an IEEE 1394 port, a dock connector for the electronic book reader 101, or the like.

In one embodiment, an effect controller 212 is configured to operate one or more of the effect generators 214a-c in response to receiving the effect request using the communication interface 210. In a further embodiment, the effect controller 212 receives the effect request via the communication interface 210, and outputs electrical signals at appropriate voltages for operating the effect generators 214a-c. In some embodiments, the effect controller 212 may include a field-programmable gate array (“FPGA”) or other programmable logic, firmware for an FPGA or other programmable logic, microcode for execution on a microcontroller, an application-specific integrated circuit (“ASIC”), or the like.

The electronic book reader 101, in the depicted embodiment, includes a user interface module 206. In one embodiment, the user interface module 206 controls input and/or output (“I/O”) devices of the electronic book reader 101 other than effect generators 214. For example, in a certain embodiment, the user interface module 206 may control a display 106. In a further embodiment, the user interface module 206 may control other I/O devices such as speakers, a microphone, a camera, hardware inputs 118, data interface 116, or the like. By controlling I/O devices, the user interface module 206 allows the electronic book reader 101 to receive an electronic book and present its contents to a user.

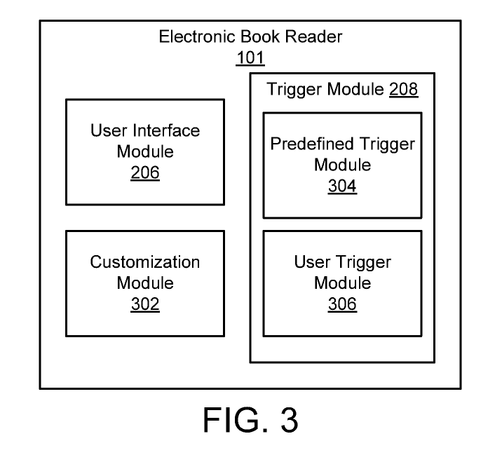

The electronic book reader 101, in the depicted embodiment, includes a trigger module 208. In one embodiment, the trigger module 208 causes the electronic book reader 101 to send an effect request using the communication interface 210 in response to a trigger. The trigger module 208 is described in further detail below with regard to the predefined trigger module 304 and the user trigger module 306 of FIG. 3.

FIG. 3 depicts a further embodiment of an electronic book reader 101. The electronic book reader 101, in certain embodiments, may be substantially similar to the electronic book reader 101 described above with regard to FIG. 2, and the electronic book reader 101 of system 100, described with regard to FIG. 1A and FIG. 1B. In the depicted embodiment, the electronic book reader 101 includes a user interface module 206 and a trigger module 208, which may be configured substantially as described above with regard to FIG. 2. The electronic book reader 101, in the depicted embodiment includes a customization module 302. The trigger module 208, in the depicted embodiment, includes a predefined trigger module 304 and a user trigger module 306.

In one embodiment, the customization module 302 is configured to receive user-selected content and present the user-selected content with the presented portion of the electronic book. In some embodiments, user-selected content may include text, sounds, images, or the like selected by a user. In a certain embodiment, the user-selected content may include content generated by the user, such as a picture taken by the user, using a camera of the electronic book reader 101. In another embodiment, the user-selected content may include content generated other than by the user, such as a sound recording generated by a person other than the user and uploaded to the electronic book reader 101 using the data interface 116.

The customization module 302 may present the user-selected content with the electronic book. For example, in one embodiment an electronic book may be customized to include the name of a user's child, and the customization module 302 may cause a user-selected picture of the child to pop up on the display 106 when the presented portion of the electronic book includes the child's name. In another embodiment, the customization module 302 may cooperate with the electronic book reader 101 to present the electronic book with user-selected content including an audio recording of the book's text. For example, in a further embodiment, the customization module 302 may allow a user's child to read a story while hearing a recording of the story in his or her parent's familiar voice.

In some embodiments, the trigger module 208 may use one or more sub-modules, such as the predefined trigger module 304 and/or the user trigger module 306, for causing the electronic book reader 101 to send an effect request using the communication interface 210 in response to a trigger. In various embodiments, the trigger module 208 may include all, some, or none of the depicted sub-modules.

In one embodiment, the predefined trigger module 304 cooperates with the electronic book reader 101 to send an effect request using the communication interface 210 automatically in response to detecting a predefined trigger within the presented portion of the electronic book. In various embodiments, a trigger may correspond to any part of an electronic book with an associated physical effect, such as a page, text, an image, a video, or another visual or audible element. In one embodiment, a trigger may be embedded in the text of an electronic book so that the predefined trigger module 304 and the electronic book reader 101 send the effect request in response to the user reaching the relevant part of the text, either by turning a page to a portion of the electronic book containing that text, or by playing a recording or text-to-speech rendering of the text that reaches that point. In another embodiment, the electronic book reader 101 may generate physical effects for a text without embedded triggers, by using programmed triggers with the predefined trigger module 304. For example, in a further embodiment, the predefined trigger module 304 may be programmed to trigger an effect request for a fan every time the electronic book reader 101 displays or audibly outputs the word “wind,” “breeze,” or the like.

An effect trigger, in one embodiment, may be programmatically defined with a command, instruction, tag, or other effect indicator embedded in computer executable code or configuration data of an electronic book. For example, in certain embodiments, the trigger module 208 may provide an application program interface (“API”), shared library, or other effects interface which an electronic book may use to trigger physical effects. In a further embodiment, as described below, the predefined trigger module 304 may reference one or more effect trigger databases mapping triggers to physical effects, and the predefined trigger module 304 may dynamically scan or monitor an electronic book for a predefined trigger, even if the electronic book itself has not been customized to include computer executable code for physical effects. An effect trigger, whether embedded in an electronic book, in an effect trigger database, or the like, may include an indicator of which physical effect is to be triggered, an indicator of a trigger event or object associated with the trigger, or the like.

In one embodiment, the user trigger module 306 cooperates with the electronic book reader 101 to send an effect request using the communication interface 210 in response to receiving user input in association with a presented portion of the electronic book. In some embodiments user input may include information received from a user via a touch-sensitive display 106, hardware inputs 118, a microphone, or the like. For example, in one embodiment, the user trigger module 306 may trigger a scent effect in response to user input indicating a scent to be emitted while an electronic book is presented. The user trigger module 306, in a further embodiment, may trigger a physical effect in response to a user touching a predefined object, element, or region in a presented portion of an electronic book, such as a displayed word, image, icon, a predefined object in an image, or another visually displayed element. As described above with regard to the predefined trigger module 304, an object, element, or region, in certain embodiments, may be marked or defined as a trigger using a command, instruction, tag, or other effect indicator.

In another embodiment, the user trigger module 306 may be voice-activated and/or configured for voice recognition, to trigger a physical effect in response to the user audibly reading certain predefined words. For example, in a further embodiment, the user trigger module 306 may be configured to trigger an effect request for a fan in response to the user trigger module 306 recognizing the user saying the word “wind” or “breeze” while reading an electronic book out loud.

In certain embodiments, the user trigger module 306 and/or the predefined trigger module may reference one or more effect trigger databases, which may include a predefined mapping of words, inputs, or other triggers to associated physical effects. An electronic book or application may include a particular effect trigger database for the user trigger module 306 and/or the predefined trigger module 304 in conjunction with the electronic book or application. In a further embodiment, a user may dynamically select, input, or configure a custom effect trigger database for the user trigger module 306 and/or the predefined trigger module 304.

In a certain embodiment, the user trigger module 306 cooperates with the predefined trigger module 304 so that the predefined trigger module 304 causes the electronic book reader 101 to present an alert, such as a graphical icon, a sound, or the like when it detects a predefined trigger, and the user trigger module 306 causes the effect request to be sent if the user input indicates that the user desires to experience the corresponding effect. Thus, users may choose to trigger some physical effects for electronic books, and ignore others, depending on individual preferences. While the physical effects and triggers of the predefined trigger module 304 and the user trigger module 306 are described above primarily in association with electronic books, in other embodiments, the predefined trigger module 304 and/or the user trigger module 306 may be configured to detect triggers and provide physical effects in association with other applications such as games or the like, with the playback of video or audio files, or in association with other content provided by the electronic book reader 101, substantially as described above with regard to electronic books.

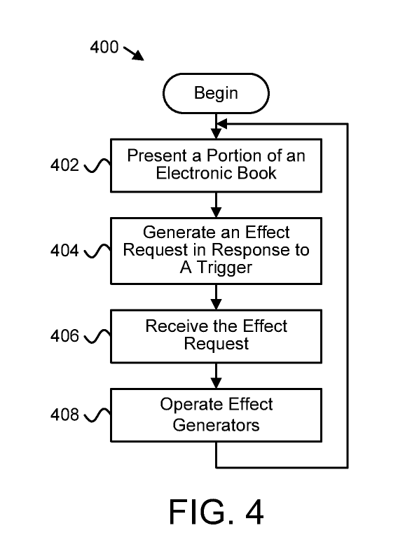

FIG. 4 depicts a method 400 for generating physical effects for electronic books. The method 400 begins, and the electronic book reader 101 presents 402 a portion of an electronic book. The trigger module 208 generates 404 an effect request in response to a trigger. In one embodiment, the trigger may include a predefined trigger within the presented portion of the electronic book. In another embodiment, the trigger may include receiving user input in association with the presented portion of the electronic book. The communication interface 210 receives 406 the effect request from the electronic book reader 101 in response to the electronic book reader 101 presenting the portion of the electronic book. The effect controller 212 operates 408 one or more one or more effect generators 214 to provide a physical effect specified by the electronic book reader 101 in response to receiving the effect request. The electronic book reader 101 continues to present 402 portions of the electronic book, and the method 400 continues.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus for generating physical effects for electronic books, the apparatus comprising:
a communication interface configured to receive an effect request from an electronic book reader in response to the electronic book reader presenting a portion of an electronic book;
one or more effect generators, each effect generator operable to provide a physical effect specified by the electronic book reader; and
an effect controller configured to operate one or more of the effect generators in response to receiving the effect request using the communication interface.

2. The apparatus of claim 1, wherein the effect request is for an air current effect associated with the presented portion of the electronic book, and an effect generator comprises a fan.

3. The apparatus of claim 1, wherein the effect request is for a temperature effect associated with the presented portion of the electronic book, and an effect generator comprises a temperature-controllable surface.

4. The apparatus of claim 1, wherein the effect request is for a scent effect associated with the presented portion of the electronic book, and an effect generator comprises a scent emitter.

5. The apparatus of claim 1, wherein the effect request is for a vibration effect associated with the presented portion of the electronic book, and an effect generator comprises a vibratable element.

6. The apparatus of claim 1, wherein the effect request is for a luminescent effect associated with the presented portion of the electronic book, and an effect generator comprises a luminescent element.

7. The apparatus of claim 1, wherein the electronic book reader sends the effect request using the communication interface automatically in response to detecting a predefined trigger within the presented portion of the electronic book.

8. The apparatus of claim 1, wherein the electronic book reader sends the effect request using the communication interface in response to receiving user input in association with the presented portion of the electronic book.

9. The apparatus of claim 1, further comprising a customization module configured to receive user-selected content and present the user-selected content with the presented portion of the electronic book.

10. The apparatus of claim 1, further comprising a housing shaped to receive the electronic book reader, the housing comprising the communication interface, the effect generators coupled to the housing.

11. A system for generating physical effects for electronic books, the system comprising:
an electronic book reader configured to present an electronic book;
a communication interface configured to receive an effect request from the electronic book reader in response to the electronic book reader presenting a portion of the electronic book;
one or more effect generators coupled to a housing of the electronic book reader, each effect generator operable to provide a physical effect specified by the electronic book reader; and
an effect controller configured to operate one or more of the effect generators in response to receiving the effect request using the communication interface.

12. The system of claim 11, wherein an effect generator comprises one or more of a fan, a temperature-controllable surface, a scent emitter, a vibratable element, and a luminescent element.

13. The system of claim 11, wherein the housing is detachably connectable to the electronic book reader.

14. The system of claim 11, wherein the housing is an integral portion of the electronic book reader.

15. The system of claim 11, wherein the electronic book reader comprises a display capable of displaying images with a three-dimensional effect.

16. The system of claim 11, wherein the electronic book reader comprises a touch-sensitive display.

17. The system of claim 11, wherein the electronic book reader is configured to display moving images.

18. The system of claim 11, wherein the electronic book reader is configured to present the electronic book by audibly reading the electronic book.

19. A method for generating physical effects for electronic books, the method comprising:
presenting a portion of an electronic book using an electronic book reader;
receiving an effect request from the electronic book reader in response to the electronic book reader presenting the portion of the electronic book; and
operating one or more effect generators to provide a physical effect specified by the electronic book reader in response to receiving the effect request.

20. The method of claim 19, further comprising generating the effect request in response to detecting a predefined trigger within the presented portion of the electronic book.
